(19) United States
(12) Patent Application Publication
(10) Pub. No.: US 2012/0288611 A1
(43) Pub. Date: Nov. 15, 2012

(54) LIQUID CREAMERS AND METHODS OF MAKING SAME

(75) Inventors: Alexander A. Sher, Dublin, OH (US); Christine Ann Beeson, Marysville, OH (US); Winnie Octavia, Delaware, OH (US); Antonio J. Gutierrez, Dublin, OH (US)

(73) Assignee: NESTEC S.A., Vevey (CH)

(21) Appl. No.: 13/511,966

(22) PCT Filed: Nov. 10, 2010
(86) PCT No.: PCT/EP10/67161

§ 371 Date: May 24, 2012

(30) Foreign Application Priority Data
Nov. 25, 2009 (US) PCT/US09/065946

(51) Int. Cl. A23C 11/02; A23C 11/06; A23C 11/08; A23C 11/04

(52) U.S. Cl. 426/602; 426/399

(57) ABSTRACT

Liquid creamers and methods of making the liquid creamers are provided. In a general embodiment, the present disclosure a liquid creamer having a specific combination of a gum component, a protein, an emulsifier system, and an oil. The emulsifier system provides the liquid creamers with good emulsion stability and manageable viscosity without phase separation during different storage conditions over the full life of the product. The liquid creamers have a good physico-chemical stability without feathering, flocculation, sedimentation and other phase separation issues when added to beverages.

### BACKGROUND

The present disclosure generally relates to food products. More specifically, the present disclosure is directed to liquid creamers for food products such as coffee and tea.

Creamers are widely used as whitening agents with hot and cold beverages, e.g. coffee, cocoa, tea. They are also often used with powders or particulates, e.g. cereals instead of milk and/or dairy cream. Creamers may also have different flavors and provide mouthfeel, body, and a smoother texture.

Creamers can be in liquid or powder forms. Powder forms do not generally provide an impression of traditional dairy creamers. Another disadvantage of using powder creamers may include difficulties in dissolution when added to coffee, and also the possibility of having a non-homogeneous beverage.

Fresh or refrigerated dairy liquid whiteners usually provide good mouthfeel. However, they are unacceptable for people with dairy intolerance. They are also inconvenient in use due to short storage capabilities. Moreover, liquid dairy creamers deteriorate rapidly even under refrigeration conditions.

The market of non-dairy creamers as coffee whiteners is rapidly growing, and the US is the market leader for this type of product. A desired whitener should be shelf-stable during storage without phase separation, creaming, gelation and sedimentation, and retain a constant viscosity over time. When added to cold or hot beverages such a coffee or tea, the creamer should dissolve rapidly, provide a good whitening capacity, and remain stable with no feathering and/or sedimentation while providing a superior taste.

It is with well known that emulsions and suspensions are not thermodynamically stable. There is a real challenge to overcome physico-chemical instability issues in the liquid creamers that contain oil and other water insoluble materials, especially for the aseptic ones during long storage times and at elevated temperatures. For example, sedimentation of titanium dioxide (“TiO₂”), which is a powerful whitening agent, may cause a decrease of whitening capacity and unacceptable visual appearance due to white layer of the sediment on the bottom of a storage container. Moreover, over time, creaming that can be still invisible in the liquid beverages stored at room and elevated temperatures can cause a plug in the bottle when refrigerated. Other undesirable issues include feathering and other types of beverage destabilizations when a liquid creamer is added to a beverage, especially in a hot, acidic environment such as coffee.

In view of the previous discussion, there are challenges in creating a homogeneous aseptic, shelf-stable liquid product without broken emulsions and phase separations while having persistent, manageable viscosity and stability during storage for several months at refrigerated or ambient temperatures. Another main challenge is to create aseptic shelf-stable liquid creamers that are easily dispersible when added to a beverage, stable in hot and cold acidic environment without feathering, breaking emulsion, de-oiling, flocculation, and sedimentation.

### SUMMARY

The present disclosure relates to liquid creamers for food products and methods of making the liquid creamers. The liquid creamers can be shelf-stable and aseptic. The liquid creamers can have high whitening capacity and a pleasant mouthfeel. The liquid creamers can maintain good physico-chemical properties, especially emulsion and suspension stability at manageable viscosity without phase separation (e.g., creaming, sedimentation, age gelation) during different storage conditions over the full life of the liquid creamer.

In a general embodiment, the present disclosure provides a liquid creamer having a gum component including a blend of kappa carrageenan and iota carrageenan in a weight ratio of about 1:2 to about 1:6, a protein ranging from about 0.5% to about 2.5% by weight, an emulsifier system including a blend of at least two emulsifiers and ranging from about 0.2 to about 0.7% by weight, and an oil ranging from about 8% to about 20% by weight. The weight ratio among the emulsifier system:protein:gum component is (2-14):(5-50):1. The % weights herein are based on the total weight of the liquid creamer unless specified otherwise.

In an embodiment, the gum component ranges from about 0.05% to about 0.10% by weight. The protein can be casein, sodium caseinate, potassium caseinate, calcium caseinate soy protein, pea protein, whey protein or a combination thereof. The emulsifiers can be monoglycerides, diglycerides, diacetyl tartaric acid esters of monoglycerides, succinic acid esters of monoglycerides or a combination thereof.

In an embodiment, the emulsifiers include low hydrophilic-lipophilic balance value emulsifiers. Alternatively, the emulsifiers can include medium hydrophilic-lipophilic balance value emulsifiers.

In an embodiment, the oil includes a vegetable oil such as soybean oil, coconut oil, palm oil, palm oil fractions, cotton seed oil, canola oil, olive oil, sunflower oil, high oleic sunflower oil, safflower oil or a combination thereof. Moreover, in an embodiment, the oil comprises a blend of vegetable oils which comprises no more than 65% saturated fatty acids, and no more than 1% trans fatty acids.

In an embodiment, the liquid creamer includes a buffering agent. The liquid creamer can also include an ingredient such as flavors, sweeteners, colorants or a combination thereof.

In another embodiment, the present disclosure provides a method of making a stable liquid creamer. The method comprises hydrating a combination of a gum component including a blend of kappa carrageenan and iota carrageenan in a weight ratio of about 1:2 to about 1:6, a protein ranging from about 0.5% to about 2.5% by weight, an emulsifier system including a blend of at least two low molecular weight emulsifiers and ranging from about 0.2 to about 0.7% by weight, and an oil ranging from about 8% to about 20% by weight to form a liquid creamer, and aseptically filling a container with the liquid creamer. The weight ratio among the emulsifier system:protein:gum component can be (2-14):(5-50):1.

In an embodiment, the method comprises heat treating the liquid creamer before filling the container. The method can also comprise homogenizing the liquid creamer before filling the container.

An advantage of the present disclosure to provide an improved shelf-stable liquid creamer.

Another advantage of the present disclosure is to provide a liquid creamer having a high whitening capacity.

Still another advantage of the present disclosure is to provide a liquid creamer that maintains a manageable viscosity over an extended storage time.

Yet another advantage of the present disclosure is to provide a liquid creamer that does not have stability issues such as de-oiling, flocculation, feathering and/or sedimentation during storage and when added to beverage at high temperature.

Another advantage of the present disclosure is to provide a liquid creamer that does not have stability issues such as de-oiling, flocculation, feathering and/or sedimentation when added to beverage at high temperature.

Still another advantage of the present disclosure is to provide a liquid creamer that has a good mouthfeel, body, smooth texture, and a good flavor without off-notes.

Additional features and advantages are described herein, and will be apparent from, the following Detailed Description.

### DETAILED DESCRIPTION

The present disclosure relates to liquid creamers and methods of making the liquid creamers. The liquid creamer can be added to any suitable beverage in an amount sufficient to provide a creaming effect to the beverage. A creaming effect imparts qualities associated with cream or dairy such as desirable, flavor, texture, body, and/or color (lightening or whitening). In alternative embodiments, the liquid creamers are stable and overcome phase separation issues (e.g., creaming, plugging, gelation, syneresis, sedimentation, etc.) during storage at refrigeration temperatures (e.g., ˜4° C.), room temperatures (e.g., ˜20° C.) and elevated temperatures (e.g., ˜30 to 38° C.). The stable liquid creamers can have a shelf-life stability, for example, for at least nine months at 20° C., 6 months at 30° C., and 1 month at 38° C. Such liquid creamers can be generally described as oil-in-water emulsions, with an aqueous continuous phase and an oily disperse phase.

It has been surprisingly found that a specific combination of a gum component, a protein, an emulsifier system, and an oil at specific ranges and weight ratios significantly improved physico-chemical stability of liquid creamers. For example, the specific combinations of these components provide stable liquid creamers with good emulsion stability and manageable viscosity without phase separation during different storage conditions over an extended period of time.

As used herein, the term “stable” means remaining in a state or condition having minimal phase separation (e.g. creaming, sedimentation, age gelation) for an extended period of time (e.g. for at least 1 month). Stable liquid creamers according to embodiments of the present disclosure can be found to be stable when maintained for at least 1 month, and are generally stable from 2 to 3 months or longer without feathering, flocculation, sedimentation issues.

The stable liquid creamers in embodiments of the present disclosure can also be easily dispersible in coffee, stable in hot and cold acidic environments without feathering, breaking emulsion, de-oiling, flocculation and sedimentation. When added to coffee, tea, cocoa or other liquid products, the liquid creamers can provide a high whitening capacity, a good mouthfeel, full body, smooth texture, and also a good flavor with no off-flavor notes developed during storage time. The liquid creamers can be used with other various food products such as cereals, as cream for berries, creamers for soups and in many cooking applications.

In a general embodiment, the present disclosure provides a liquid creamer having a gum component including a blend of kappa carrageenan and iota carrageenan in a weight ratio of about 1:2 to about 1:6, a protein ranging from about 0.5% to about 2.5% by weight, an emulsifier system including a blend of at least two emulsifiers and ranging from about 0.2 to about 0.7% by weight, and an oil ranging from about 8% to about 20% by weight. The weight ratio among the emulsifier system:protein:gum component can be (2-14):(5-50):1, respectively.

In an embodiment, the gum component includes a blend of kappa carrageenan and iota carrageenan in a weight ratio of about 1:2.5 to about 1:4. In another embodiment, the emulsifier system includes a blend of at least two emulsifiers and ranges from about 0.3 to about 0.6% by weight of the liquid creamer.

In an embodiment, the gum component ranges from about 0.05% to about 0.10% by weight. The protein can be casein, sodium caseinate, potassium caseinate, calcium caseinate, soy protein, pea protein, whey protein or a combination thereof.

The emulsifier system can include a combination of at least two low molecular weight emulsifiers at the specific weight ratios. The type of emulsion can be controlled by the emulsifiers, and the emulsifiers should be soluble in the continuous phase. For stable oil in water emulsion, typically emulsifiers with high hydrophilic-lipophilic balance (“HLB”) values should provide the best stability. However, it was surprisingly found that the combination of low molecular weight emulsifiers with low and medium HLB values provided the best emulsion stability of liquid creamers at the specific weight ratios between the emulsifiers with low and medium HLB values.

The hydrophilicity and lipophilicity are different among emulsifiers, and the balance between the two is called the HLB value. The HLB value is determined by calculating hydrophilic or lipophilic values of the different regions of the molecule. Various references discuss the HLB value. Examples are Griffin WC: “Classification of Surface-Active Agents by ‘HLB,’” Journal of the Society of Cosmetic Chemists 1 (1949): 311, or Griffin WC: “Calculation of HLB Values of Non-Ionic Surfactants,” Journal of the Society of Cosmetic Chemists 5 (1954): 259, which are incorporated herein by reference. The HLB value of an emulsifier typically ranges from 0 to 20.

Low HLB values range from about 1 to about 5. Medium HLB values range from about 5 to about 10. Low molecular weight emulsifiers with low HLB values can include, but are not limited to, monoglycerides, diglycerides, acetylated monoglycerides, sorbitan trioleate, glycerol dioleate, sorbitan tristearate, propyleneglycol monostearate, glycerol monooleate and monostearate, alone or in combination. The low molecular weight emulsifiers with medium HLB values can include, but are not limited to, sorbitan monooleate, propylene glycol monolaurate, sorbitan monostearate, calcium stearoxyl-2-lactylate, glycerol sorbitan monopalmitate, soy lecithin, and diacetylated tartaric acid esters of monoglycerides, alone or in combination.

In an embodiment, the emulsifiers are monoglycerides (“MG”), diglycerides (“DG”), diacetyl tartaric acid esters of monoglycerides (“TMG”) or a combination thereof having the specified low or medium HLB values. It was further found that particular weight ratios of the emulsifiers achieved superior stability. In an embodiment, the weight ratio between MG and DG can be about 7:1 to about 9.5:1, respectively. In another embodiment, the weight ratio between MG and TMG can be about 1:2.5 to about 1:4.5, respectively.

In an embodiment, the oil includes one or more vegetable oils. The oils can provide creaminess and mouthfeel to the creamer. The oils can also participate in the whitening effect of the creamer. The vegetable oil(s) can include partially or wholly hydrogenated oils, alone or in combination. For example, the vegetable oils can include but are not limited to soybean oil, coconut oil, palm oil, palm oil fractions, cotton seed oil, canola oil, olive oil, sunflower oil, safflower oil or a combination thereof. The sunflower oil can be high oleic sunflower oil. The oils can be blended in any suitable amount and manner to ensure maximum oxidation stability. For instance, the oil can include a blend of vegetable oils which comprises no more than 65% saturated fatty acids. In an embodiment, the blend of vegetable oils comprises no more than 1% trans fatty acids.

The oil is the main component of the disperse phase in the emulsion. In an embodiment, the average diameter of the oil droplets is lower than 0.6 microns. Preferably, the oil droplets have a diameter ranging from about 0.25 microns to 0.45 microns. The oil droplets of the emulsion in this range of particle size provide an optimal whitening effect.

In an embodiment, the liquid creamer excludes a cellulose. For example, the liquid creamers can be made without using any cellulose ingredients such as microcrystalline cellulose and carboxy-methyl cellulose.

In an embodiment, the liquid creamer includes a buffering agent. The buffering agent can prevent undesired creaming or precipitation of the creamer upon addition into a hot, acidic environment such as coffee. The buffering agent can be, for example, monophosphates, diphosphates, sodium mono- and bicarbonates, potassium mono- and bicarbonates or a combination thereof. More specifically, non-limiting examples of suitable buffers are salts such as potassium phosphate, dipotassium phosphate, potassium hydrophosphate, sodium bicarbonate, sodium citrate, sodium phosphate, disodium phosphate, sodium hydrophosphate, and sodium tripolyphosphate. The buffer can be present in an amount of about 0.5 to about 1% of the total weight of the liquid creamer.

In an embodiment, the liquid creamer can include a whitening agent in an amount sufficient to provide further whitening to an aqueous media to which the liquid creamer is added. For example, the whitening agent can be TiO₂, which can be present in an amount of about 0.1% to about 1% by weight of the liquid creamer. The TiO₂ can have a particle size ranging from about 0.1 to about 0.7 microns, with a preferred embodiment having a particle size of 0.4 microns. When TiO₂ is used as a complementary whitener, the TiO₂ can be maintained in full suspension throughout the liquid creamer shelf-life. Other suitable whitening agents can also be used such as calcium carbonate, calcium sulfate, and aluminum oxide.

In another embodiment, the particulate size of the whitening agent ranges between 0.3 and 0.5 microns. The optimum size of the whitening agent is obtained when light scattering is delivering the most intense white color. This is related to the wavelength considered and for the whole visible spectrum the optimum size would be half the average wavelength or around 0.30 microns. It may be expected that a smaller size would make the liquid creamer itself bluish in color, whereas a larger size would progressively decrease the whitening power. Using a particle size around a mean of 0.30 microns should be beneficial at least on two accounts. The increased whitening power results in less of the whitening component needed for the same end color, which allows for a cost reduction. The smaller particles are easier to suspend and keep suspended. Generally speaking, suspended particles are governed by the Stokes' law terminal velocity in term of gravitational force providing a tendency for settling. However, at particle size lower than about 2.0 microns, other forces become significant and also control the settling or suspension. It is well known that below 2.0 microns Brownian motion predominates and the gravitational forces becomes less and less important as the size is reduced, thus favoring suspension of small particles without much settling.

The liquid creamer can also include one or more ingredients such as flavors, sweeteners, colorants or a combination thereof. Sweeteners can include, for example, sucrose, fructose, dextrose, maltose, dextrin, levulose, tagatose, galactose, corn syrup solids and other natural or artificial sweeteners. Sugarless sweeteners can include, but are not limited to, sugar alcohols such maltitol, xylitol, sorbitol, erythritol, mannitol, isomalt, lactitol, hydrogenated starch hydrolysates, and the like, alone or in combination.

Usage level of the flavors, sweeteners and colorants will vary greatly and will depend on such factors as potency of the sweetener, desired sweetness of the product, level and type of flavor used and cost considerations. Combinations of sugar and/or sugarless sweeteners may be used in the liquid creamers. In an embodiment, the sweetener is present in the liquid creamer at a concentration ranging from about 20% to about 50% by weight. In another embodiment, the sweetener ranges from about 25% to about 35% by weight.

In another embodiment, the present disclosure provides a method of making a stable liquid creamer. Advantageously, in alternative embodiments, the stable liquid creamers can possess physico-chemical stability for at least nine months at 20° C., three months at 30° C. and one month at 38° C., without any deterioration of their desirable properties.

The method comprises hydrating a combination of a gum component including a blend of kappa carrageenan and iota carrageenan in a weight ratio of about 1:2 to about 1:6, a protein ranging from about 0.5% to about 2.5% by weight, an emulsifier system including a blend of at least two low molecular weight emulsifiers and ranging from about 0.2 to about 0.7% by weight, and an oil ranging from about 8% to about 20% by weight to form a liquid creamer, homogenizing the liquid creamer, and aseptically filling a container with the liquid creamer. The hydrating can be done with water or any other suitable liquid. The weight ratio among the emulsifier system:protein:gum component can be (2-14):(5-50):1, respectively.

The hydration of gums, emulsifiers, proteins, buffer(s), sweetener(s) and flavor(s) in water can be done under agitation with the addition of melted oil/fat, followed by heat treatment, homogenization, cooling and filling aseptic containers under aseptic conditions. Aseptic heat treatment may use direct or indirect ultra high temperature (“UHT”) processes. UHT processes are known in the art. Examples of UHT processes include UHT sterilization and UHT pasteurization.

Direct heat treatment is performed by injecting steam water in the emulsion. In this case, it may be necessary to remove excess water, by flashing. Indirect heat treatment is performed with a heat transfer interface in contact with the emulsion. The homogenization could be performed before and/or after heat treatment. It may be interesting to perform homogenization before heat treatment in order to improve heat transfers in the emulsion, and thus achieve an improved heat treatment. Performing a homogenization after heat treatment usually ensures that the oil droplets in the emulsion have the desired dimension. Aseptic filling is described in various publications, such as articles by L, Grimm in “Beverage Aseptic Cold Filling” (Fruit Processing, July 1998, p. 262-265), by R. Nicolas in “Aseptic Filling of UHT Dairy Products in HDPE Bottles” (Food Tech. Europe, March/April 1995, p. 52-58) or in U.S. Pat. No. 6,536,188 B1 to Taggart, which are incorporated herein by reference.

The aseptic liquid creamer, when added to a beverage, produces a physically stable homogeneous whitened drink with a good mouthfeel, and body, smooth texture, and a pleasant taste with no off-flavors notes. The use of the liquid creamers is not limited for only coffee applications. For example, the creamers can be also used for other beverages, such as tea or cocoa, or used with cereals or berries, creamers for soups, and in many cooking applications, etc.

### EXAMPLES

By way of example and not limitation, the following examples are illustrative of various embodiments of the present disclosure.

### Example 1

A dry blend of carrageenan with sucrose was prepared by mixing together 500 g of sucrose with 20 g of kappa-carrageenan and 50 g of iota-carrageenan. The dry blend was added into 58 kg of hot water at about 75° C., under high agitation in a tank. Then, 400 g of di-potassium phosphate was added to the tank under continuous agitation.

Next, a dry blend was prepared by mixing together 900 g of sodium caseinate, 300 g of titanium dioxide, 330 g of flavors and 2.5 kg of sucrose. The dry blend was added to the tank under high agitation. After about 10 minutes of mixing, emulsifiers (100 g of Dimodan and 300 g of Panodan) were added into the tank under continuous high agitation. Further, 8.4 kg of melted oil at about 60° C. was added under high agitation, followed by 27 kg of sucrose. Small amount of additional water was added to adjust the total product weight to 100 kg.

The resulting liquid was pre-heated, UHT treated for 5 seconds at 143° C., homogenized at 180/40 bar, cooled and the liquid creamer was aseptically filled into bottles. Liquid creamers can also be aseptically filled in any aseptic containers, e.g. jars, jugs or pouches.

Three sets of bottles containing the liquid creamer were stored under the following conditions:
one month at 38° C.,
three months at 30° C., and
nine months at room temperature (about 20° C.).

Physico-chemical stability and sensory profile of creamer and coffee beverage with added liquid creamer were judged by non-trained panelists. No phase separation (creaming, de-oiling, marbling, etc), gelation, sedimentation and practically no viscosity changes were found during the storage.

It was found that the liquid creamer had a good appearance, mouth-feel, smooth texture and a good flavor without “off” taste. Further, the creamer showed high whitening capacity when added to a coffee.

### Example 2

A dry blend of carrageenan with sucrose was prepared by mixing together 500 g of sucrose with 10 g of kappa-carrageenan and 30 g of iota-carrageenan. The dry blend was added into 58 kg of hot water at about 75° C., in a tank, under high agitation. Then, 400 g of di-potassium phosphate was added to the tank under continuous agitation.

Next, a dry blend was prepared by mixing together 1.0 kg of sodium caseinate, 300 g of titanium dioxide, 330 g of flavors and 2.5 kg of sucrose. The dry blend was added to the tank under high agitation. After about 10 minutes of mixing, emulsifiers (100 g of Dimodan and 300 g of Panodan) were added into the tank under continuous high agitation. Further, 8.4 kg of melted oil at about 60° C. was added under high agitation, followed by 27 kg of sucrose. Small amount of additional water was added to adjust the total product weight to 100 kg.

The resulting liquid was pre-heated, UHT treated for 5 seconds at 143° C., homogenized at 180/40 bar, cooled and the liquid creamer was aseptically filled into bottles.

Three sets of bottles containing the liquid creamer were stored under the following conditions:
one month at 38° C.,
three months at 30° C., and
nine months at room temperature (about 20° C.).

Physico-chemical stability and sensory profile of creamer and coffee beverage with added liquid creamer were judged by non-trained panelists. No phase separation (creaming, de-oiling, marbling, etc), gelation, sedimentation and practically no viscosity changes were found during the storage.

It was found that the liquid creamer had a good appearance, mouth-feel, smooth texture and a good flavor without “off” taste. Further, the creamer showed high whitening capacity when added to a coffee.

### Example 3

A dry blend of carrageenan with sucrose was prepared by mixing together 500 g of sucrose with 10 g of kappa-carrageenan and 30 g of iota-carrageenan. The dry blend was added into 58 kg of hot water at about 75° C., in a tank, under high agitation. Then, 400 g of di-potassium phosphate was added to the tank under continuous agitation.

Next, a dry blend was prepared by mixing together 1.0 kg of sodium caseinate, 300 g of titanium dioxide, 330 g of flavors and 2.5 kg of sucrose. The dry blend was added to the tank under high agitation. After about 10 minutes of mixing, emulsifiers (130 g of Dimodan and 380 g of Panodan) were added into the tank under continuous high agitation. Further, 8.4 kg of melted oil at about 60° C., was added under high agitation, followed by 27 kg of sucrose. Small amount of additional water was added to adjust the total product weight to 100 kg.

The resulting liquid was pre-heated, UHT treated for 5 seconds at 143° C., homogenized at 180/40 bar, cooled. Then the liquid creamer was aseptically filled into bottles.

Three sets of bottles containing the liquid creamer were stored under the following conditions:
one month at 38° C.,
three months at 30° C., and
nine months at room temperature (about 20° C.).

Physico-chemical stability and sensory profile of creamer and coffee beverage with added liquid creamer were judged by non-trained panelists. No phase separation (creaming, de-oiling, marbling, etc), gelation, sedimentation and practically no viscosity changes were found during the storage.

It was found that the liquid creamer had a good appearance, mouth-feel, smooth texture and a good flavor without “off” taste. Further, the creamer showed high whitening capacity when added to a coffee.

### Example 4

A coffee whitener was prepared as in Example 1 but using only kappa-carrageenan instead of blend of kappa- and iota-carrageenan blend. Physico-chemical stability and sensory profile of liquid creamer and coffee beverage with added liquid creamer were judged by non-trained panelists.

After 4-months storage at 20° C., the sensory evaluation showed creaming in the bottle. Further, a significant sedimentation of the liquid creamer in the bottle was observed. When added to coffee, a significant decrease of whitening capacity as compared to the fresh made liquid coffee creamer was observed.

### Example 5

A coffee whitener was prepared as in Example 1 but using total of 900 g of the two emulsifiers, instead of a total of 70 g. Physico-chemical stability and sensory profile of liquid creamer and coffee beverage with added liquid creamer was judged by non-trained panelists.

After 3-months storage at 20° C., the sensory evaluation showed significant creaming in the bottle. When added to coffee, a significant decrease of whitening capacity as compared to the fresh made liquid coffee creamer was observed.

### Example 6

A coffee whitener was prepared as in Example 1 but using 3.0 kg of sodium caseinate. Physico-chemical stability and sensory of liquid creamer and coffee beverage with added liquid creamer was judged by non-trained panelists.

After 3-weeks storage at 38° C., the sensory evaluation showed flocculation in the bottle. Further, a significant increase of viscosity the liquid creamer was observed.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A liquid creamer comprising:
a gum component comprising a blend of kappa carrageenan and iota carrageenan in a weight ratio of about 1:2 to about 1:6;
a protein comprising from about 0.5% to about 2.5% by weight;
an emulsifier system comprising a blend of at least two emulsifiers and ranging comprising from about 0.2 to about 0.7% by weight, wherein-the weight ratio among of the emulsifier system:protein:gum component is (2-14):(5-50):1; and
an oil ranging-comprising from about 8% to about 20% by weight.

2. The liquid creamer of claim 1, wherein the gum component ranges comprises from about 0.05% to about 0.10% by weight.

3. The liquid creamer of claim 1, wherein the protein is selected from the group consisting of casein, sodium caseinate, potassium caseinate, calcium caseinate, soy protein, pea protein, whey protein and combinations thereof.

4. The liquid creamer of claim 1, wherein the emulsifiers are selected from the group consisting of monoglycerides, succinic acid esters of monoglycerides, diacetyl tartaric acid esters of monoglycerides and combinations thereof.

5. The liquid creamer of claim 1, wherein the emulsifiers comprise low hydrophilic-lipophilic balance value emulsifiers.

6. The liquid creamer of claim 1, wherein the emulsifiers comprise medium hydrophilic-lipophilic balance value emulsifiers.

7. The liquid creamer of claim 1, wherein the oil comprises a vegetable oil selected from the group consisting of soybean oil, coconut oil, palm oil, palm oil fractions, cotton seed oil, canola oil, olive oil, sunflower oil, high oleic sunflower oil, safflower oil and combinations thereof.

8. The liquid creamer of claim 7, wherein the vegetable oil comprises no more than 65% saturated fatty acids and no more than 1% trans fatty acids.

9. The liquid creamer of claim 1, comprising a buffering agent.

10. The liquid creamer of claim 1, comprising an ingredient selected from the group consisting of flavors, sweeteners, colorants and combinations thereof.

11. A method of making a stable liquid creamer comprising:
hydrating a combination of a gum component comprising a blend of kappa carrageenan and iota carrageenan in a weight ratio of about 1:2 to about 1:6, a protein ranging from about 0.5% to about 2.5% by weight, an emulsifier system comprising a blend of at least two low molecular weight emulsifiers and comprising from about 0.2 to about 0.7% by weight, and an oil ranging from about 8% to about 20% by weight to form a liquid creamer;
homogenizing the liquid creamer; and
aseptically filling a container with the liquid creamer.

12. The method of claim 11, wherein the weight ratio of the emulsifier system:protein:gum component is (2-14):(5-50):1.

13. The method of claim 11 comprising heat treating the liquid creamer before filling the container.
